(19) United States
(12) Patent Application Publication
(10) Pub. No.: US 2008/0300979 A1
(43) Pub. Date: Dec. 4, 2008

(54) Method and apparatus of customer relationship management and maketing

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/809,827

(22) Filed: May 31, 2007

(51) Int. Cl. G06Q 30/00

(52) U.S. Cl. 705/14

(57) ABSTRACT

A method, apparatus, and system of customer relationship management and marketing are disclosed. In one embodiment, a method of generating a personalized communication for a customer includes obtaining a purchase record of the customer from a first data source, obtaining a location of the customer from a second data source, integrating the purchase record and the location in a geo-spatial map, analyzing a targeting criteria of the customer and of people residing adjacent to the customer through a referencing of the purchase record and the location of the customer with public and wiki generated information of the customer and the people residing adjacent to the customer, generating the personalized communication based on the analysis, and sending the personalized communication to the customer and the people residing adjacent to the customer.

### FIELD OF TECHNOLOGY

This disclosure relates generally to the technical fields of communications and, in one example embodiment, to a method, apparatus, and system of customer relationship management and marketing.

### BACKGROUND

Customer relationship management (CRM) may refer to a set of techniques and concepts used by businesses to manage relationships with their customers, including collection, storage, and analysis of customer information. CRM strategies may aim to learn more about customer needs and/or behaviors by obtaining customer information and/or market trends from a variety of sources. The customer information may then be analyzed with a goal of providing better services and/or products to customers, offering better customer service, faster execution of business deals, more effective cross selling of products, and/or expanding a customer base.

CRM may encompass four major parts: active, operational, collaborative, and analytical. Active CRM may be used to centralize data about prospective customers, current customers, and/or ordering information under one system. The data may also be sorted, managed, tracked, and/or analyzed to improve customer relationships and create targeted marketing campaigns. The data may also be used to automate certain business tasks and processes.

Operational CRM provides support to sales, marketing, service, and other front end business processes. Information about a customer's interaction with the business may be stored in a customer's contact history, which may be retrieved by a staff member to provide better service to the customer.

Collaborative CRM may include direct interaction with customers. Direct interaction may include “self-service” communication via email, internet, and interactive voice response (IVR) over telephone. Collaborative CRM may be used to reduce costs and improve customer service. Additionally, collaborative CRM may provide a comprehensive view of the customer by pooling customer data from different sales and communications channels

Analytical CRM may be used to analyze customer data for a variety of purposes. Analytical CRM often uses predictive analytic techniques, such as regression techniques and machine learning techniques, to predict future trends in customer behavior. Results of analytical CRM may be used for designing and executing targeted marketing campaigns, product and service decision making, making management decisions such as financial forecasting and customer profitability analysis, and risk assessment and fraud detection. As such, analytical CRM is limited in the ability to provide geographic information regarding customer trends. Current analytical CRM techniques may not be able to provide visualization and/or other methods of interpreting the complexity of neighborhood information and customer behavior patterns.

### SUMMARY

A method, apparatus and system of customer relationship management and marketing are disclosed. In one aspect, a method of generating a personalized communication (e.g., selected from a group consisting of a letter, an email, a text message, an instant message, and/or an embedded advertisement) for a customer includes obtaining a purchase record of the customer from a first data source (e.g., a point of sale system, a shopping club archive, and/or an online purchase), obtaining a location (e.g., the location may consist of a latitude and a longitude) of the customer from a second data source (e.g., a public record), integrating the purchase record and the location in a geo-spatial map (e.g., associated with a social network of the customer) analyzing a targeting criteria of the customer and of people residing adjacent to the customer through a referencing of the purchase record and the location of the customer with public and wiki generated information of the customer and the people residing adjacent to the customer, generating the personalized communication based on the analysis, and sending the personalized communication to the customer and the people residing adjacent to the customer.

The method may further include determining a neighborhood of the customer and the people residing adjacent to the customer using the geo-spatial map, and sending the personalized communication to the neighborhood of the customer.

In another aspect, a customer relationship management system includes a customer repository configured to store customer data (e.g., a name of a customer and a location of the customer), a geo-spatial map, and a marketing analysis module configured to integrate the customer data into the geo-spatial map, analyze the customer data based on geo-spatial data and a user-generated data associated with a neighborhood encompassing the location (e.g., the location may consist of a longitude and a latitude), and generate a personalized communication for the customer based on the analysis.

The customer relationship management system may include a user interface consisting of a mapping utility configured to display the geo-spatial map (e.g., operatively connected to a social network of the customer) to a user, a neighborhood locator configured to obtain the location from the user, a purchase tracker configured to display the customer data integrated into the geo-spatial map, and a communication utility configured to display a communication option (e.g., a letter, an email, a text message, an instant message, and/or an embedded advertisement) to the user.

The customer relationship management system may also include a marketing analysis module. The marketing analysis module may be further configured to determine a neighborhood of the customer using the geo-spatial map, and send the personalized communication to the neighborhood of the customer.

In yet another aspect, a method of generating a personalized communication (e.g., selected from a group consisting of a letter, an email, a text message, an instant message, and/or an embedded advertisement) for a neighborhood includes obtaining a purchase record of a customer in the neighborhood from a first data source (e.g., a point of sale system, a shopping club archive, and/or an online purchase), obtaining a location (e.g., the location may consist of a latitude and a longitude) of the customer from a second data source (e.g., a public record), integrating the purchase record and the location in a geo-spatial map (e.g., associated with a social network of the customer), analyzing a targeting criteria of the customer and of people in the neighborhood through a referencing of the purchase record and the location of the customer with public and wiki generated information of the customer an people in the neighborhood, generating the personalized communication based on the analysis, and sending the personalized communication to the customer and the people in the neighborhood.

The methods, systems, and apparatuses disclosed herein may be implemented in any means for achieving various aspects, and may be executed in a form of a machine-readable medium embodying a set if instructions that, when executed by a machine, cause the machine to preform ant of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a customer relationship management system communicating with a point of sale system through a network, according to one embodiment.

FIG. 2 is an exploded view of the customer relationship management system of FIG. 1, according to one embodiment.

FIG. 3 is a block diagram of the customer relationship management system of FIG. 1, according to one embodiment.

FIG. 4 is a user interface view of the customer relationship management system of FIG. 1, according to one embodiment.

FIG. 5 is a user interface view displaying core customer groups in a geo-spatial map, according to one embodiment.

FIG. 6 is a user interface view of a customer webpage, according to one embodiment.

FIG. 7 is a user interface view showing offers in a particular neighborhood, according to one embodiment.

FIG. 8 is a flow chart for generating and sending personalized communication to a customer and the neighborhood of the customer, according to one embodiment.

FIG. 9 is a diagrammatic system view of a data processing system in which any of the embodiments disclosed herein may be performed, according to one embodiment.

FIG. 10 is a process flow of generating the personalized communication for the customer, according to one embodiment.

FIG. 11 is the process flow of generating the personalized communication for a neighborhood, according to one embodiment.

Other features of the present embodiments will be apparent from the accompanying drawings and from the detailed description that follows.

### DETAILED DESCRIPTION

A method, apparatus and system of customer relationship management and marketing are disclosed. In the following description, for the purposes of explanation, numerous specific details are set forth in order to provide a thorough understanding of the various embodiments. It will be evident, however to one skilled in the art that the various embodiments may be practiced without these specific details.

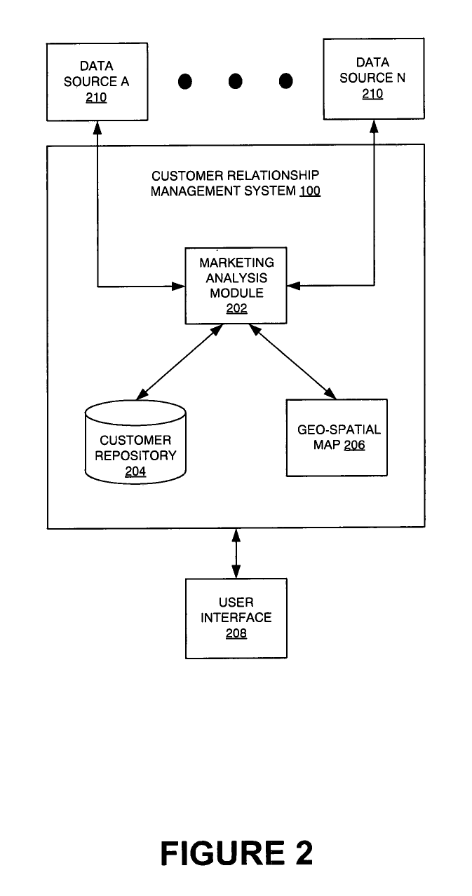

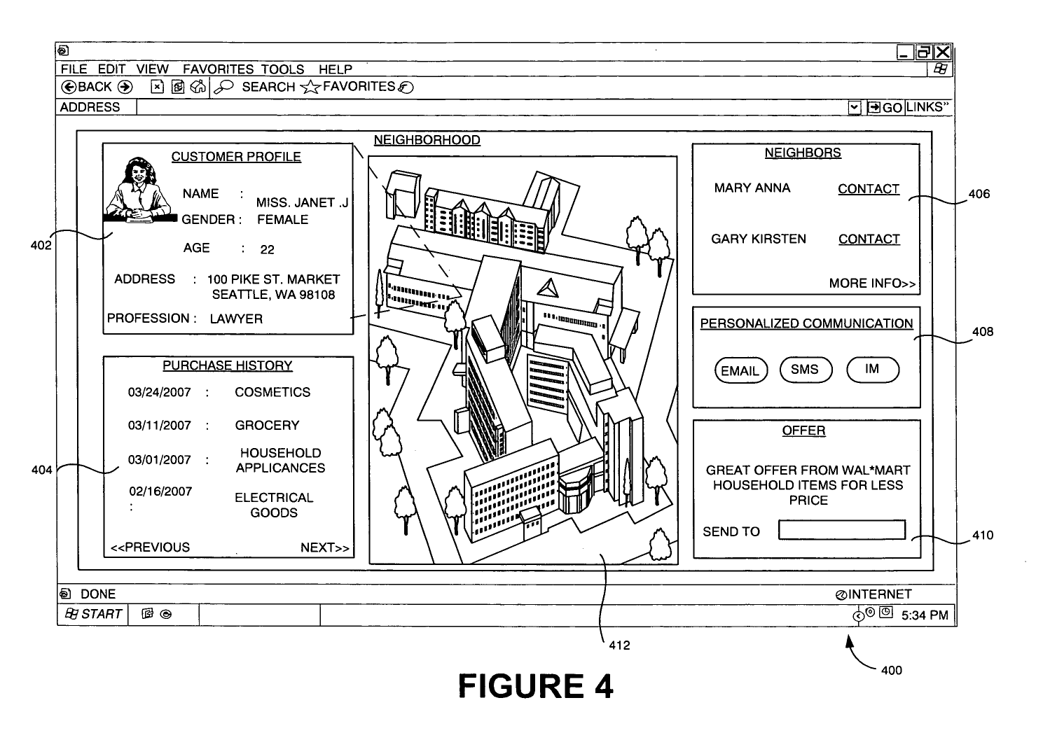

In one embodiment, a method of generating a personalized communication (e.g., the personalized communication 408 of FIG. 4) for a customer includes obtaining a purchase record of the customer from a first data source (e.g., the data source 210A-N of FIG. 2), obtaining a location of the customer from a second data source (e.g., the data source 210A-N of FIG. 2), integrating the purchase record and the location in a geo-spatial map (e,g., the geo-spatial map 206 of FIG. 2), analyzing a targeting criteria of the customer and of people residing adjacent to the customer through a referencing of the purchase record and the location of the customer with public and wiki generated information of the customer and the people residing adjacent to the customer, generating the personalized communication based on the analysis, and sending the personalized communication to the customer and the people residing adjacent to the customer.

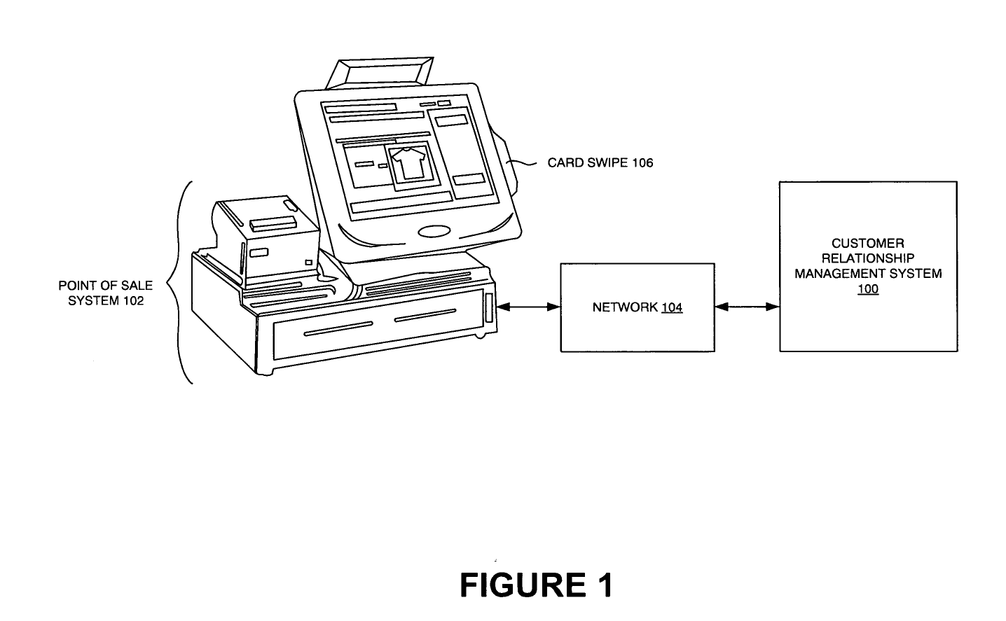

In another embodiment, a customer relationship management system (e.g., the customer relationship management system 100 of FIGS. 1, 2 and 3) includes a customer repository (e.g., the customer repository 204 of FIG. 2) configured to store customer data, a geo-spatial map, and a marketing analysis module (e.g., the marketing analysis module 202 of FIG. 2) configured to integrate the customer data into the geo-spatial map, analyze the customer data based on geo-spatial data and/or user-generated data associated with a neighborhood encompassing the location, and generate a personalized communication for the customer based on the analysis.

In yet another embodiment, a method of generating a personalized communication for a neighborhood includes obtaining a purchase record of a customer in the neighborhood from a first data source, obtaining a location of the customer from a second data source, integrating the purchase record and the location in a geo-spatial map, analyzing a targeting criteria of the customer and of people in the neighborhood through a referencing of the purchase record and the location of the customer with public and wiki generated information of the customer and people in the neighborhood, generating the personalized communication based on the analysis, and sending the personalized communication to the customer and the people in the neighborhood.

FIG. 1 is a system view of a customer relationship management system 100 communicating with a point of sale system 102 through a network 104, according to one embodiment. Particularly, FIG. 1 illustrates the customer relationship management system 100, the point of sale system 102, the network 104 and a card swipe 106, according to one embodiment.

The customer relationship management system 100 may enable entities (e.g., businesses, organizations, etc.) to maintain relationships with their customers using the customer data stored in the point of sale system 102 through the network 104 (e.g., the internet). The point of sale system 102 may be an electronic cash register system used to store purchase records of the customers.

The point of sale system 102 may be placed at a checkout counter at a business (e.g., restaurants, hotels, stadiums, casinos, etc.) where a transaction occurs between the customers and the entity. The network 104 may enable communication between the customer relationship management system 100 and the point of sale system 102. The card swipe 106 may be an electronic device attached to the point of sale system 102 to read an encoded data contained in a swipe card (e.g., a credit card, a debit card, etc.) while passing the swipe card through the card swipe 106 (e.g., used especially for transaction processes).

In the example embodiment illustrated in FIG. 1, the card swipe 106 is attached to the point of sale system 102 to read information (e.g., customer name, location, etc.) associated with the customer and store to the point of sale system 102 when the transactions processes are carried out by using the swipe cards.

The customer relationship management system 100 communicates with the point of sale system 102 through the network 104. A purchase record of the customer may be obtained from a first data source (e.g., a point of sale system, a shopping club archive, and/or an online purchase). The location (e.g., a latitude and a longitude) of the customer may be obtained from a second data source (e.g., a public record).

FIG. 2 is an exploded view of the customer relationship management system 100 of FIG. 1, according to one embodiment. Particularly, FIG. 2 illustrates a marketing analysis module 202, a customer repository 204, a geo-spatial map 206, a user interface 208 and data source 210A-N, according to one embodiment.

The marketing analysis module 202 may analyze the customer data (e.g., name and location of the customer) and determine the information associated with people in neighborhood of the customer using the geo-spatial map 206. In addition, the marketing analysis module 202 may generate and send the personalized communication (e.g., a letter, an email, a text message, etc.) to the customer and to the people in the neighborhood based on the analysis.

The customer repository 204 may be a central database configured to store the customer data (e.g., name and location) associated with the customer obtained during the transaction process between the customer and the entity. The geo-spatial map 206 may geo-spatially track the location of the customer and people in the neighborhood of the customer based on the customer data.

The user interface 208 may display the customer data and the location of the customer in the geo-spatial map 206. The user interface 208 may provide a communication option to users (e.g., customer, people in the neighborhood) and/or the entities. The data source 210A-N may be a public record, a point of sale system, a shopping club archive, and/or an online purchase which provides information associated with the purchase records of the customer to customer relationship management (CRM) system 100.

In the example embodiment illustrated in FIG. 2, the marketing analysis module 202 communicates with the customer repository 204, the geo-spatial map 206, and the data source 210A-N. The customer relationship management system 100 containing the marketing analysis module 202, the customer repository 204, and the geo-spatial map 206 communicates with the user interface 208.

A purchase record of a customer may be obtained from a first data source (e.g., the data sources 210A-N of FIG. 2). A location (e.g., a latitude and a longitude) of the customer may be obtained from a second data source (e.g., the data sources 210A-N of FIG. 2). The purchase record and the location may be integrated in the geo-spatial map 206.

A targeting criteria of the customer and of people residing adjacent to the customer may be analyzed through a referencing of the purchase record and the location of the customer with public and wiki generated information of the customer and the people residing adjacent to the customer. The personalized communication (e.g., a letter, an email, a text message, an instant message, and/or an embedded advertisement) may be generated based on the analysis.

The personalized communication (e.g., the personalized communication 408 of FIG. 4) may be sent to the customer and the people residing adjacent to the customer. The neighborhood of the customer and the people residing adjacent to the customer may be determined using the geo-spatial map 206. The personalized communication 408 may be sent to the neighborhood of the customer. The geo-spatial map 206 may be associated with a social network of the customer.

The customer repository 204 may be configured to store the customer data (e.g., name of a customer and a location of the customer). The marketing analysis module 202 may be configured to integrate the customer data into the geo-spatial map 206 (e.g., operatively connected to the social network 306 of the customer). The marketing analysis module 202 may also analyze the customer data based on a geo-spatial data and a user-generated data associated with the neighborhood encompassing the location.

In addition, the marketing analysis module 202 may generate a personalized communication for the customer based on the analysis. A mapping utility may be configured to display the geo-spatial map 206 to a user. A neighborhood locator may be configured to obtain the location from the user. A purchase tracker may be configured to display the customer data integrated into the geo-spatial map 206. A communication utility may be configured to display a communication option (e.g., the email, the SMS, the IM of the personalized communication 408 of FIG. 4) to the user.

The marketing analysis module 202 may be further configured to determine the neighborhood of the customer using the geo-spatial map 206. In addition, the marketing analysis module 202 may send the personalized communication to the neighborhood of the customer.

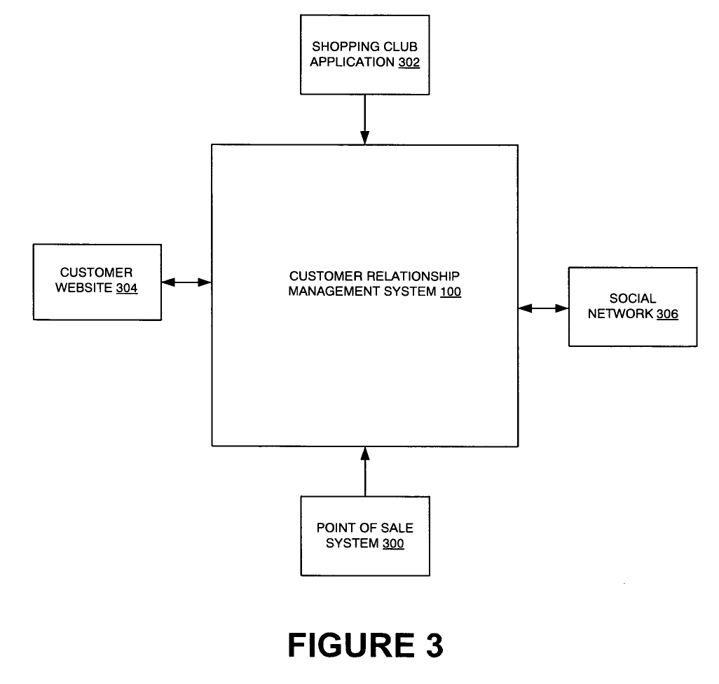

The purchase record of the customer in the neighborhood may be obtained from the first data source (e.g., the point of sale system 102 of FIGS. 1, 3). The location of the customer may be obtained from the second data source (e.g., the public record). The purchase record and the location may be integrated in the geo-spatial map 206. A targeting criteria of the customer and of people in the neighborhood may be analyzed through a referencing of the purchase record and the location of the customer with public and wiki generated information of the customer and people in the neighborhood. The personalized communication may be generated based on the analysis. The personalized communication may be sent to the customer and the people in the neighborhood.

FIG. 3 is block diagram of a customer relationship management system 100 of FIG. 1, according to one embodiment. Particularly, FIG. 3 illustrates the customer relationship management system 100, a point of sale system 300, a shopping club application 302, a customer website 304 and a social network 306, according to one embodiment.

The customer relationship management system 100 may enable management of customer relationship to the entity (e.g., an organization, businesses, etc.) through analyzing the information associated with the customer and the people in the neighborhood. The point of sale system 300 may be the electronic cash register system which provides the customer data to the customer relationship management system 100.

The shopping club application 302 may be a software program developed to track the customer data (e.g., a purchase record, a location) of the customer and generate the personalized communication for the customer based on the analysis. The customer website 304 may be a website created by the entities to facilitate online transactions of goods and/or services between the entities and the customer. The social network 306 may be a network in which the customers, the people in the neighborhood of the customer and the entities interact with each other.

In the example embodiment illustrated in FIG. 3, the customer relationship management system 100 interacts with the customer website 304 and the social network 306. The point of sale system 300 and the shopping club application 302 provide the customer data associated with the customer to the customer relationship management system 100.

FIG. 4 is a user interface view 400 of the customer relationship management system 100 of FIG. 1, according to one embodiment. Particularly, FIG. 4 illustrates a customer profile 402, a purchase history 404, a neighbors block 406, a personalized communication option 408, an offer block 410, and a 3D map view 412, according to one embodiment.

The customer profile 402 may display the personal information (e.g., name, age, gender, profession, etc) and location information (e.g., city, country, zip code, etc.) of the customer. The purchase history 404 may display the purchase records associated with the customer obtained from the various data source.

The neighbors' block 406 may display the profile information (e.g., name, location, profession, etc.) associated with the people residing adjacent to the customer in the neighborhood. The personalized communication option 408 may enable entities to generate and send the personalized communication (e.g., an email, a SMS, an instant messenger, etc.) based on the analysis of customers purchase habits.

The offer block 410 may facilitate the entities to provide each individual (e.g., the customer, people residing adjacent to the customer, etc.) a personalized offer(s) (e.g., a price, personalized recommendations, etc.) based on the analysis. The 3D map view 412 may graphically visualize in a map, the location of the customer and also enable the entities to determine the neighborhood of the customer and/or people residing adjacent to the customer.

In the example embodiment illustrated in FIG. 4, the user interface view 400 displays the customer page created by a particular entity. The user interface view 400 displays the customers' profile 402, the purchase history 404 of the customer, and the profiles associated with the neighbors 406 in the neighborhood of the customer. The purchase history displays the type of purchased product and date of purchase.

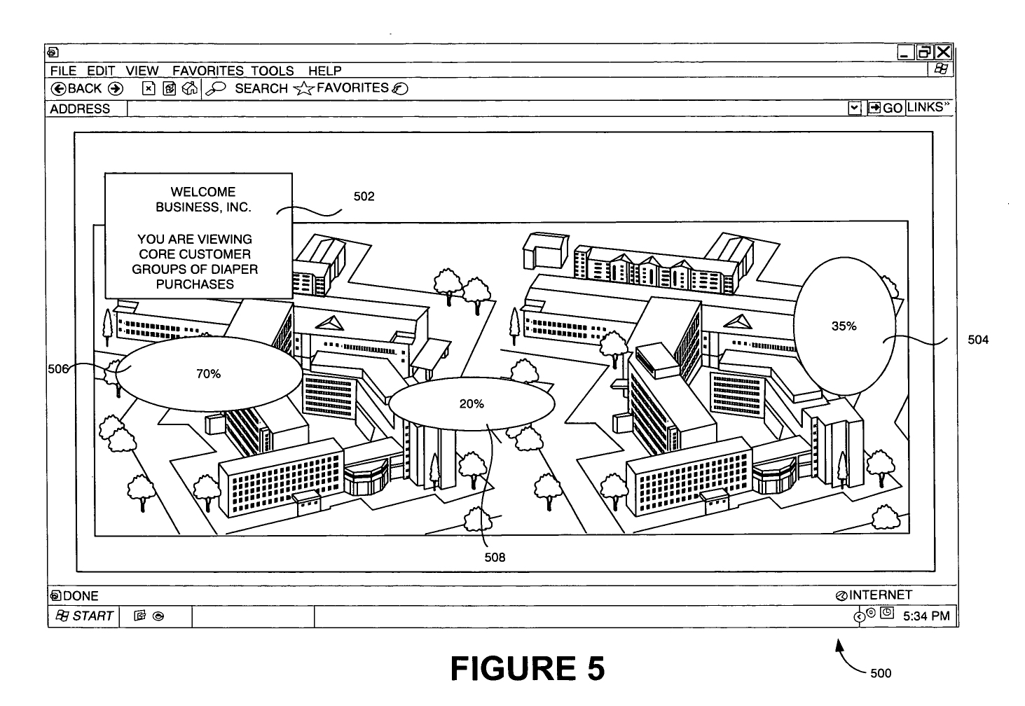

FIG. 5 is a user interface view 500 displaying the core customer groups in a geo-spatial map, according to one embodiment. Particularly, FIG. 5 illustrates a block 502, a customer group 504, 506, and 508, according to one embodiment.

The block 502 may display a density of core customer groups purchasing a particular product in the geo-spatial environment. The customer groups 504, 506 and 508 may display percentages (e.g., frequency metrics) at which the same product is purchased by the customer and the people in the neighborhood based on the targeting criteria analysis of the customer data associated with the customer.

In the example embodiment illustrated in FIG. 5, the user interface view 500 displays the purchasing criteria of the customer groups in different neighborhoods for a diaper purchase. The block 502 displays “Welcome Business, Inc. You are viewing core customer groups of diaper purchases”. The user interface view 500 displays the customer groups 504, 506 and 508 in the geo-spatial map.

The customer group 504 shows that the purchasing habits of a particular customer group (e.g., a particular customer and/or people in the neighborhood) for the diaper purchase is 35% based on the results of the analysis. The customer group 506 shows that the purchasing habits of another customer group for the diaper purchase is 70% based on the results of the analysis. Similarly, the customer group 508 represents the purchasing habits as 20% for the diaper purchase in yet another neighborhood displayed in the geo-spatial map.

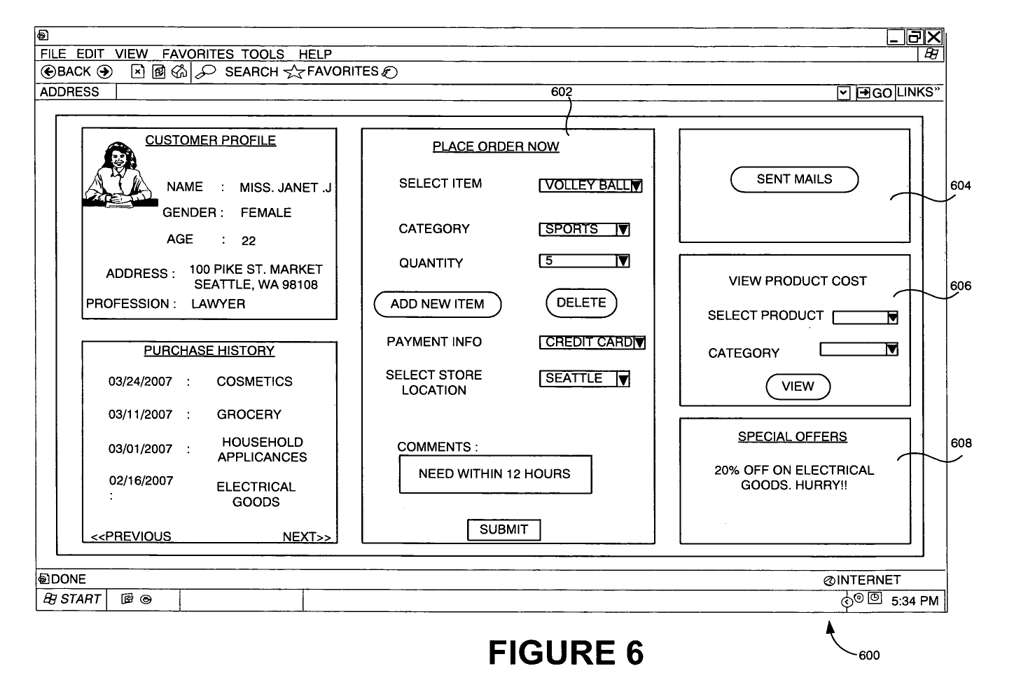

FIG. 6 is a user interface view 600 of a customer webpage, according to one embodiment. Particularly, FIG. 6 illustrates a place order now option 602, a sent mails option 604, a view product cost option 606, and an offers block 608, according to one embodiment.

The place order now option 602 may enable the customer to place an order for the products and/or services. In addition, the place order now option 602 may enable the customer to provide payment information associated with the order. The sent mails option 604 may contain records of previous mails associated with the orders placed by the customer. The view product cost option 606 may prompt a query to the customer to enter the search data (e.g., product name, category, etc.) and display the cost associated with the product. The offers block 608 may display advertisements and/or the specific offers sent by the entities to the customer.

In the example embodiment illustrated in FIG. 6, the user interface view 600 shows the personalized communication sent by the entity to the customer. The user interface view 600 displays the customer profile and the purchase history of the customer. The user interface view 600 also displays the place order now option to order the new goods and/or services from the entity associated with the location. The place order now option 602 may enable the customer to select the product, the category and the quantity.

The user interface view 600 also displays an option to pay a bill through electronic payments (e.g., using credit card, online banking, etc.). The user interface view 600 may enable the customers to post comments and/or feedback (e.g., quality of products, services, etc.) on and/or to the entity. In addition, the user interface view 600 displays the special offers offered by the entity to the customer.

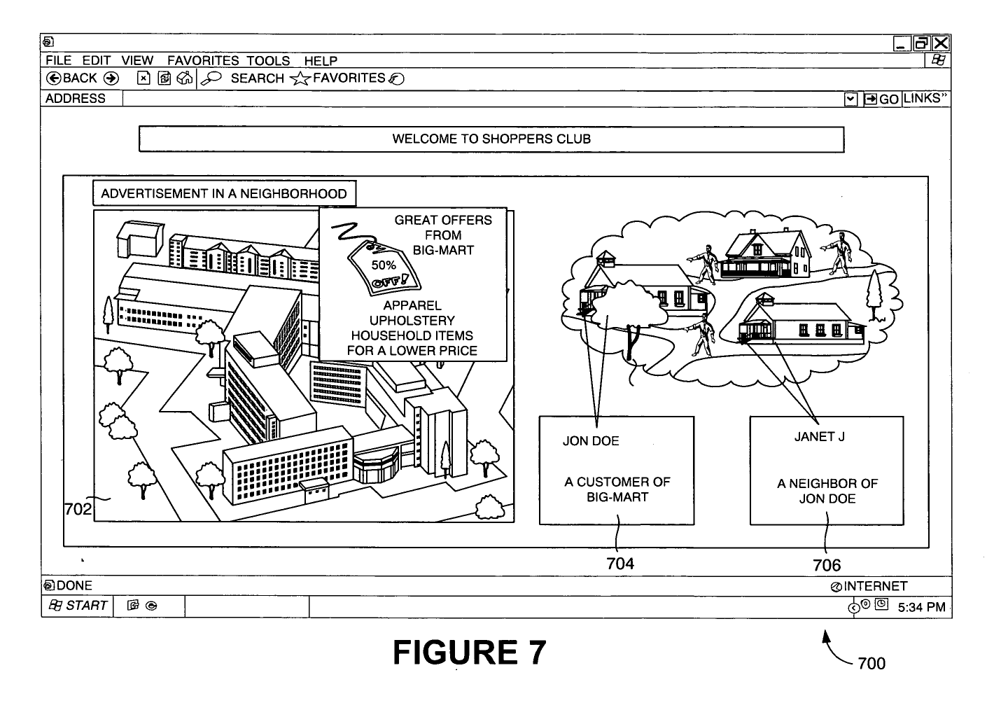

FIG. 7 is a user interface view 700 showing the offers in a particular neighborhood, according to one embodiment. Particularly, FIG. 7 illustrates the neighborhood 702, a customer 704, and a neighbor 706, according to one embodiment.

The neighborhood 702 may display the offers provided by businesses to a particular neighborhood. The block 704 may display the customer data of a particular customer associated with a particular entity. The block 706 may represent the information associated with a neighbor residing adjacent to the customer in the neighborhood.

In the example embodiment illustrated in FIG. 7, the user interface view 700 displays the promotion “apparels, upholstery, household items for a lower price” offered to the customer and the people in the neighborhood by the entity (e.g., Big-Mart) in the neighborhood of the geo-spatial network. The block 704 displays “Jon Doe-a customer of Big-Mart” associated with a particular location. The block 706 displays “Janet J, a neighbor of Jon Doe” associated with a location adjacent to the customer in the neighborhood.

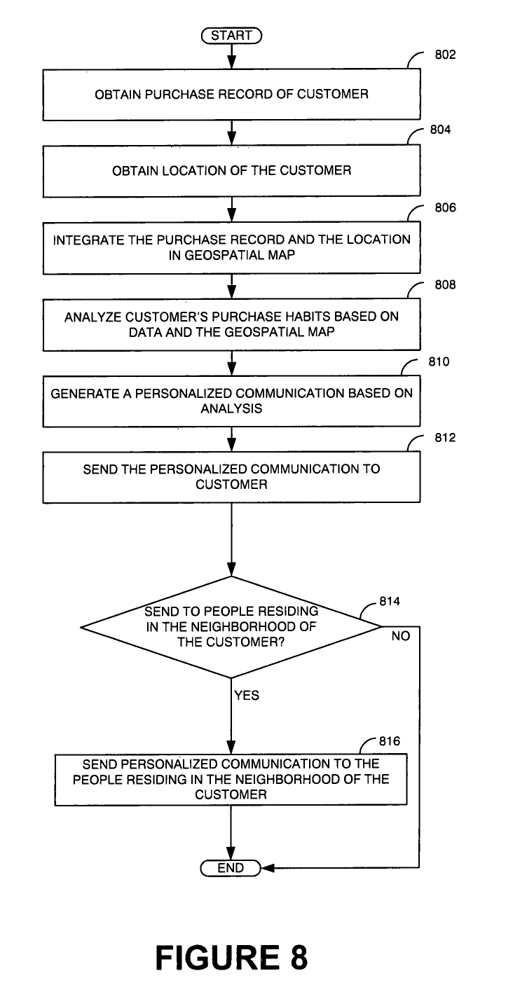

FIG. 8 is a flow chart for generating and sending the personalized communication to the customer and the neighborhood of the customer, according to one embodiment. In operation 802, the purchase record (e.g., name) of the customer is obtained from the first data source (e.g., the point of sale system, the shopping club archive, online purchase, etc.).

In operation 804, a location of the customer is obtained from public data (e.g., a profile of the customer in the geo-spatial environment) associated with the purchase record of the customer. In operation 806, the purchase record and the location are integrated in the geo-spatial map. In operation 808, the customer's purchase habits are analyzed based on the customer data (e.g., the purchase records, the location, etc.) and the geo-spatial map.

In operation 810, a personalized communication (e.g., a letter, a email, a text message, etc.) is generated based on the analysis. In operation 812, the personalized communication is sent to the customer. In operation 814, a condition (e.g., whether to send the personal communication to the people in the neighborhood of the customer or not) is determined based on the analysis. In operation 816, the personalized communication is sent to the people in the neighborhood of the customer based on the condition of operation 814.

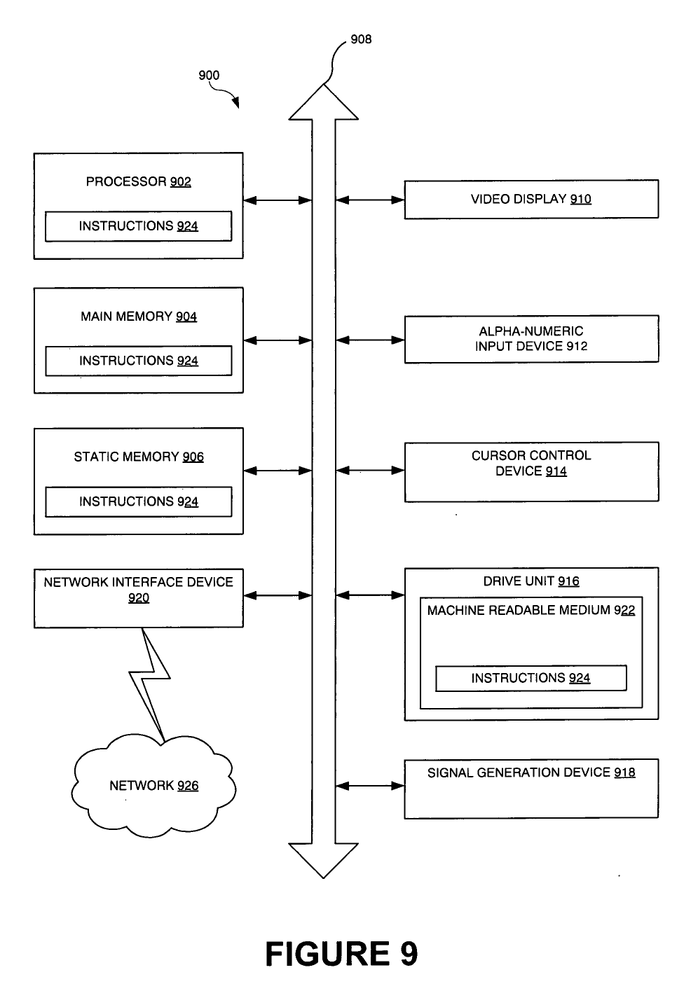

FIG. 9 is a diagrammatic system view 900 of a data processing system in which any of the embodiments disclosed herein may be performed, according to one embodiment. Particularly, the system view 900 of FIG. 9 illustrates a processor 902, a main memory 904, a static memory 906, a bus 908, a video display 910, an alpha-numeric input device 912, a cursor control device 914, a drive unit 916, a signal generation device 918, a network interface device 920, a machine readable medium 922, instructions 924, and a network 926, according to one embodiment.

The diagrammatic system view 900 may indicate a personal computer and/or a data processing system in which one or more operations disclosed herein are performed. The processor 902 may be a microprocessor, a state machine, an application specific integrated circuit, a field programmable gate array, etc. (e.g., Intel® Pentium® processor). The main memory 904 may be a dynamic random access memory and/or a primary memory of a computer system.

The static memory 906 may be a hard drive, a flash drive, and/or other memory information associated with the data processing system. The bus 908 may be an interconnection between various circuits and/or structures of the data processing system. The video display 910 may provide graphical representation of information on the data processing system. The alpha-numeric input device 912 may be a keypad, a keyboard and/or any other input device of text (e.g., a special device to aid the physically handicapped). The cursor control device 914 may be a pointing device such as a mouse.

The drive unit 916 may be a hard drive, a storage system, and/or other longer term storage subsystem. The signal generation device 918 may be a bios and/or a functional operating system of the data processing system. The network interface device 920 may be a device that may perform interface functions such as code conversion, protocol conversion and/or buffering required for communication to and from the network 926. The machine readable medium 922 may provide instructions on which any of the methods disclosed herein may be performed. The instructions 924 may provide source code and/or data code to the processor 902 to enable any one/or more operations disclosed herein.

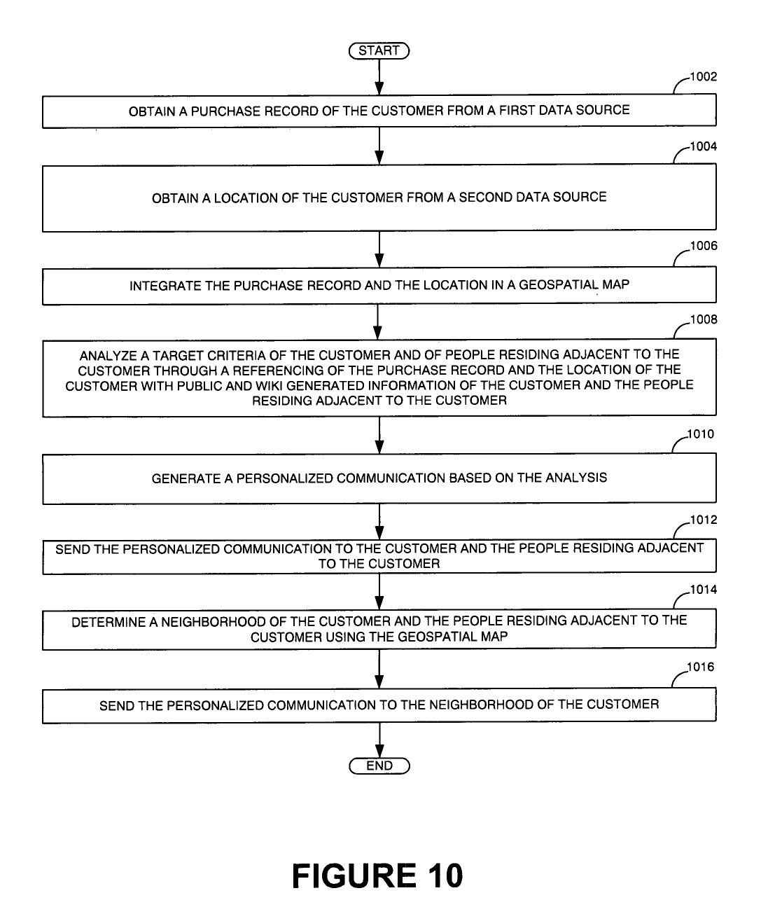

FIG. 10 is a process flow of generating a personalized communication for a customer, according to one embodiment. In operation 1002, a purchase record of the customer may be obtained from a first data source (e.g., the data sources 210A-N of FIG. 2). In operation 1004, a location of the customer may be obtained from a second data source (e.g., the data sources 210A-N of FIG. 2). In operation 1006, the purchase record and the location may be integrated in a geo-spatial map (e,g., the geo-spatial map 206 of FIG. 2).

In operation 1008, a targeting criteria of the customer and of people residing adjacent to the customer may be analyzed through a referencing of the purchase record and the location of the customer with public and wiki generated information of the customer and the people residing adjacent to the customer. In operation 1010, a personalized communication may be generated based on the analysis (e.g., using the customer relationship management system 100 of FIG. 1 and/or the marketing analysis module 202 of FIG. 2)

In operation 1012, the personalized communication may be sent to the customer and the people residing adjacent to the customer. In operation 1014, a neighborhood of the customer and the people residing adjacent to the customer may be determined using the geo-spatial map (e.g., the geo-spatial map 206, as illustrated in FIG. 2). In operation 1016, the personalized communication may be sent to the neighborhood of the customer.

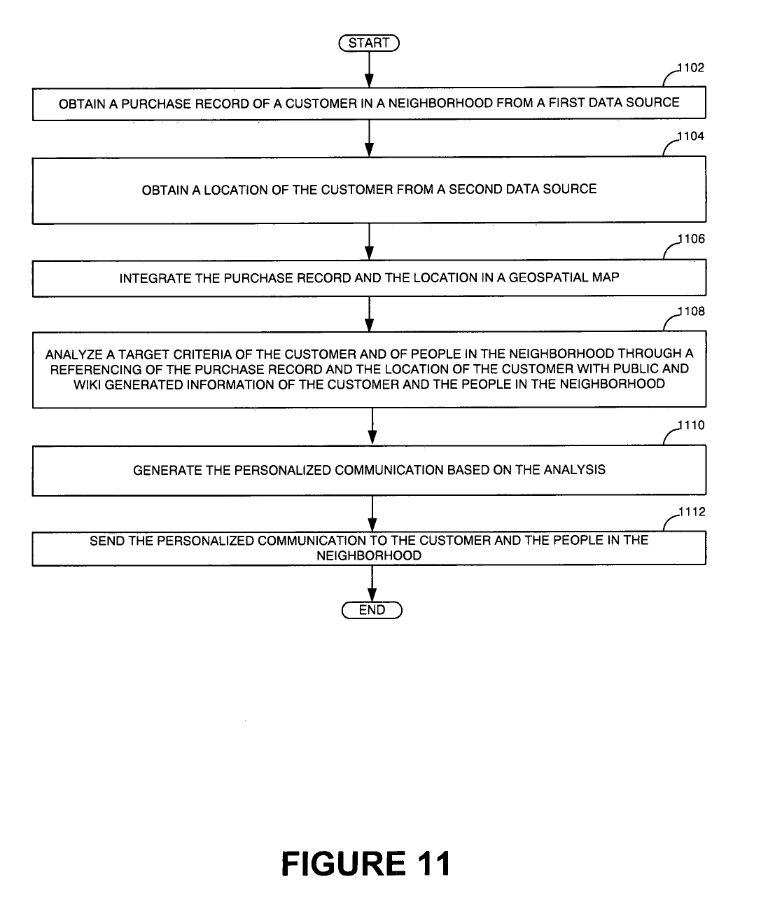

FIG. 11 is a process flow of generating a personalized communication for a neighborhood, according to one embodiment. In operation 1102, a purchase record of a customer in a neighborhood may be obtained from a first data source. In operation 1104, a location of the customer may be obtained from a second data source (e.g., the data source 210A-N of FIG. 2). In operation 1106, the purchase record and the location may be integrated in a geo-spatial map (e.g., the geo-spatial map 206, as illustrated in FIG. 2).

In operation 1108, a targeting criteria of the customer and of people in the neighborhood may be analyzed through a referencing of the purchase record and the location of the customer with public and wiki generated information of the customer and the people in the neighborhood (e.g., using the marketing analysis module 202 of FIG. 2). In operation 1110, the personalized communication may be generated based on the analysis. In operation 1112, the personalized communication may be sent to the customer and the people in the neighborhood (e.g., FIG. 7 illustrates an advertisement in a neighborhood within the geo-spatial map 206).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry). For example, the marketing analysis module 202 and the other modules of FIGS. 1-11 may be enabled using a marketing analysis circuit and other circuits, using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of generating a personalized communication for a customer, comprising:
obtaining a purchase record of the customer from a first data source;
obtaining a location of the customer from a second data source;
integrating the purchase record and the location in a geo-spatial map;
analyzing a targeting criteria of the customer and of people residing adjacent to the customer through a referencing of the purchase record and the location of the customer with public and wiki generated information of the customer and the people residing adjacent to the customer;
generating the personalized communication based on the analysis; and
sending the personalized communication to the customer and the people residing adjacent to the customer.

2. The method of claim 1, further comprising:
determining a neighborhood of the customer and the people residing adjacent to the customer using the geo-spatial map; and
sending the personalized communication to the neighborhood of the customer.

3. The method of claim 1, wherein the first data source is at least one selected from a group consisting of a point of sale system, a shopping club archive, and an online purchase.

4. The method of claim 1, wherein the second data source comprises a public record.

5. The method of claim 1, wherein the personalized communication is at least one selected from a group consisting of a letter, an email, a text message, an instant message, and an embedded advertisement.

6. The method of claim 1, wherein the location comprises a latitude and a longitude.

7. The method of claim 1, wherein the geo-spatial map is associated with a social network of the customer.

8. The method of claim 1 in a form of a machine-readable medium embodying a set of instructions that, when executed by a machine, causes the machine to perform the method of claim 1.

9. A customer relationship management system, comprising:
a customer repository configured to store customer data, wherein the customer data comprises a name of a customer and a location of the customer;
a geo-spatial map; and
a marketing analysis module configured to:
integrate the customer data into the geo-spatial map,
analyze the customer data based on geo-spatial data and user-generated data associated with a neighborhood encompassing the location, and
generate a personalized communication for the customer based on the analysis.

10. The customer relationship management system of claim 9, further comprising:
a user interface, comprising:
a mapping utility configured to display the geo-spatial map to a user;
a neighborhood locator configured to obtain the location from the user;
a purchase tracker configured to display the customer data integrated into the geo-spatial map; and
a communication utility configured to display a communication option to the user.

11. The customer relationship management system of claim 10, wherein the communication option is at least one selected from a group consisting of a letter, an email, a text message, an instant message, and an embedded advertisement.

12. The customer relationship management system of claim 9, wherein the market analysis module is further configured to:
determine a neighborhood of the customer using the geo-spatial map; and
send the personalized communication to the neighborhood of the customer.

13. The customer relationship management system of claim 9, wherein the location comprises a latitude and a longitude.

14. The customer relationship management system of claim 9, wherein the geo-spatial map is operatively connected to a social network of the customer.

15. A method of generating a personalized communication for a neighborhood, comprising:
obtaining a purchase record of a customer in the neighborhood from a first data source;
obtaining a location of the customer from a second data source;
integrating the purchase record and the location in a geo-spatial map;
analyzing a targeting criteria of the customer and of people in the neighborhood through a referencing of the purchase record and the location of the customer with public and wiki generated information of the customer and the people in the neighborhood;
generating the personalized communication based on the analysis; and
sending the personalized communication to the customer and the people in the neighborhood.

16. The, method of claim 15, wherein the first data source is at least one selected from a group consisting of a point of sale system, a shopping club archive, and an online purchase.

17. The method of claim 15, wherein the second data source comprises a public record.

18. The method of claim 15, wherein the personalized communication is at least one selected from a group consisting of a letter, an email, a text message, an instant message, and an embedded advertisement.

19. The method of claim 15, wherein the location comprises a latitude and a longitude.

20. The method of claim 15, wherein the geospatial map is associated with a social network of the customer.
